(19) United States
(12) Patent Application Publication
(10) Pub. No.: US 2005/0289271 A1
(43) Pub. Date: Dec. 29, 2005

(54) Circuitry to selectively produce MSI signals

(76) Inventors: Alberto J. Martinez, El Dorado Hills, CA (US); James S. Chapple, Chandler, AZ (US); Prashant Sethi, Folsom, CA (US); Joseph A. Bennett, Roseville, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/881,076

(22) Filed: Jun. 29, 2004

(51) Int. Cl. G06F 13/24

(52) U.S. Cl. 710/260

(57) ABSTRACT

In some embodiments, the inventions include a chip having a status register circuit coupled to conductors to receive interrupt event signals to provide source signals corresponding to the interrupt event signals. The chip also includes a control register circuit to provide source enable signals for selective ones of the interrupt sources, and a re-arming logic circuit coupled to the conductors to receive the interrupt event signals and provide a re-arming signal. The chip further includes first logic circuit to receive the source signals, the source enable signals, and the re-arming signal to provide an initial interrupt signal, and message signaled interrupt (MSI) signal pulse generation logic to receive the initial interrupt signal and provide an MSI signal in response thereto. Other embodiments are described and claimed.

### BACKGROUND

1. Technical Field

The present inventions relate to circuitry to selectively produce message signaled interrupt (MSI) signals and to related systems.

2. Background Art

Message signaled interrupts (MSI) were defined in the Peripheral Components Interconnect (PCI) Local Bus Specification v2.0 to improve system performance by reducing signal interrupt sharing in a heavily integrated or PCI device loaded system. Following the PCI v2.0 specification, PCI-X and PCI Express interconnect architectures have adopted MSI for event notification and interrupt delivery. While MSI provides a processor direct messaging system, it also changes the PCI interrupt signaling semantics from level triggered to edge triggered, which might impact system driver functionality, compatibility, and performance.

In PCI terminology, INTx is an interrupt that represents one of INTA, INTB, INTC, or INTD. As originally defined, PCI interrupts signaled through pin INTx use a level-triggered semantics. This allows the INTx to be shared among devices and allows internal PCI device events to share INTx assertion within a given device.

FIG. 1 illustrates a typical device INTx internal architecture sharing. Referring to FIG. 1, circuitry 10 includes a generic interrupt event status register and clear register circuit 28 (hereinafter “status register circuit 28”). Status register circuit 28 functions as a latch for interrupt event pulses captured by external logic and provided from event sources 1 . . . N on conductors 22-1 . . . 22-N. (XXh is a value in hexadecimal notation.) A latch of status register circuit 28 is cleared by writing a value of “1” to a register input for the specific bit for the source event. There may be N event sources. Although FIG. 1 illustrates status register circuit 28 as a single box, it may be comprised of multiple physically separate circuits.

Generic interrupt control register circuit 32 functions as a latch for the host command to enable interrupt reporting for a specific event. In the example, a value of “1” indicates enable. The specific control bit is cleared by writing “0” to a register input. The figure represents N control bits. Although FIG. 1 illustrates generic interrupt control register circuit 32 as a single box, it may be comprised of multiple physically separate circuits.

AND logic 48-1 . . . 48-N each receive a status source signal 1 . . . signal N from outputs 34-1 . . . 34-N of status register circuit 28 and a source enable signal from outputs 40-1 . . . 40-N from interrupt control register circuit 32. Outputs of AND logic 48-1 . . . 48-N are provided to an OR logic 52. The output of OR logic 52 is provided as an input to AND logic 54. Accordingly, if for any of the sources, both the status source signal and the source enable signals are asserted (in the example, asserted=1=high), the output of OR logic 52 is also asserted.

Master interrupt control register circuit 60 functions as a latch for a host command to enable global interrupt reporting for the device interrupt logic. A value of “1” indicates enable. The specific control bit is cleared by writing “0” to a register input.

AND logic 54 receives an interrupt enable signal from output 64 of control register circuit 60. AND logic 54 gates the captured event as presented by OR logic 52. The gate of AND logic 54 is closed when the control bit of interrupt control register circuit 60 is “0” (logic low in this example). The output of AND logic 54 on conductor 66 is coupled to the external pin denominated as INTx and exposes level triggered semantics to the interrupt controller logic in the system.

In the examples of this disclosure, “0” represents a logic low voltage and “1” represents a logic high voltage. In the example of FIG. 1, outputs 34-1 and 40-1 are “1” and outputs 34-N and 40-N are “0.” Output 64 is a “1”. Accordingly, the output of AND logic 48-1 is “1”, the output AND logic 48-N is “0”, the output of OR logic 52 is “1” and the output of AND logic 54 (which is INTx) is “1”.

In the simplest case, a device driver is code executing in the central processing unit (CPU) at operating system Ring 0 level. A section of this code in charge of the interrupt signaling is called the interrupt service routine (ISR). The ISR is invoked when a signal from the actual device is sent to the CPU. In level trigger semantics (LTS), the interrupt is asserted until the event causing the interrupt is cleared by the execution of ISR.

A well defined driver ISR disables the interrupts, will identify all possible interrupt sources inside the specific controller, save this information, and launch an auxiliary process to attend each event and finally clear the status on the controller and re-enable interrupts before exiting the ISR itself. The description above applies to a well architected driver executing in a properly defined interrupt architecture where all status bits reside in a single register accessed.

For level trigger semantics, the driver should be recalled under any possible circumstance where an interrupting event is generated and the specific status bit is not cleared. Under proper conditions, this removes the possibility for an ISR to miss an event generated by hardware while enabling the capability for multiple devices supporting level trigger semantics to share the interrupt pin as in the case of PCI architecture.

MSI was adopted in PCI Spec v2.0 to improve system performance by removing the latency introduced by multiple ISR chained in a single interrupt. MSI was later adopted by PCI-X and PCI Express architectures for event notification and interrupt delivery. A premise is to allow a processor direct messaging system thus removing the need of a physical pin per interrupt signal and the related need to share the pin as valuable resource. However, MSI changes the original PCI interrupt signaling semantics from level triggered to edge triggered as the MSI itself is a single message delivered to the CPU and no pin is held asserted until the interrupt itself is cleared. In other words, once the event is detected, a message is sent and no electrical signal is held asserted until drive clears the status.

The system described above works well if there is only a single event in the specific device that is capable of generating an interrupt message. However, in reality, devices contain multiple possible events capable of generating interrupts and basically causing an interrupt sharing of the MSI functionality internally to the controller.

### BRIEF DESCRIPTION OF THE DRAWINGS

The inventions will be understood more fully from the detailed description given below and from the accompanying drawings of embodiments of the inventions which, however, should not be taken to limit the inventions to the specific embodiments described, but are for explanation and understanding only.

FIG. 1 is a schematic block diagram representation of a prior art circuit for PCI interrupts.

FIG. 2 is a schematic block diagram representation of a system in which circuitry according to FIGS. 4-6 may be used according to some embodiments of the inventions.

FIG. 3 is a schematic block diagram representation of circuitry that may be used to generate MSI signals.

FIG. 4 is a schematic block diagram representation of circuitry to generate MSI signals according to some embodiments of the inventions.

FIG. 5 is a schematic block diagram representation of circuitry to generate MSI signals according to some embodiments of the inventions.

FIG. 6 is a schematic block diagram representation of a portion of FIGS. 4 and 5 in combination with a portion of FIG. 1 according to some embodiments of the inventions.

### DETAILED DESCRIPTION

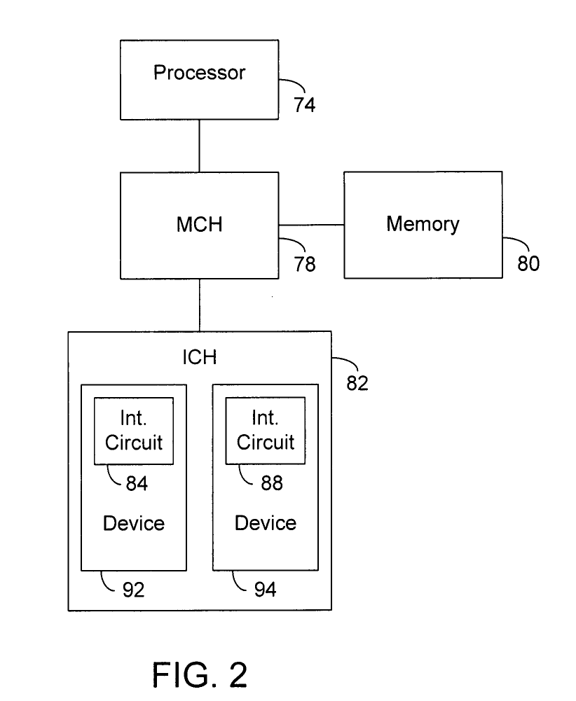

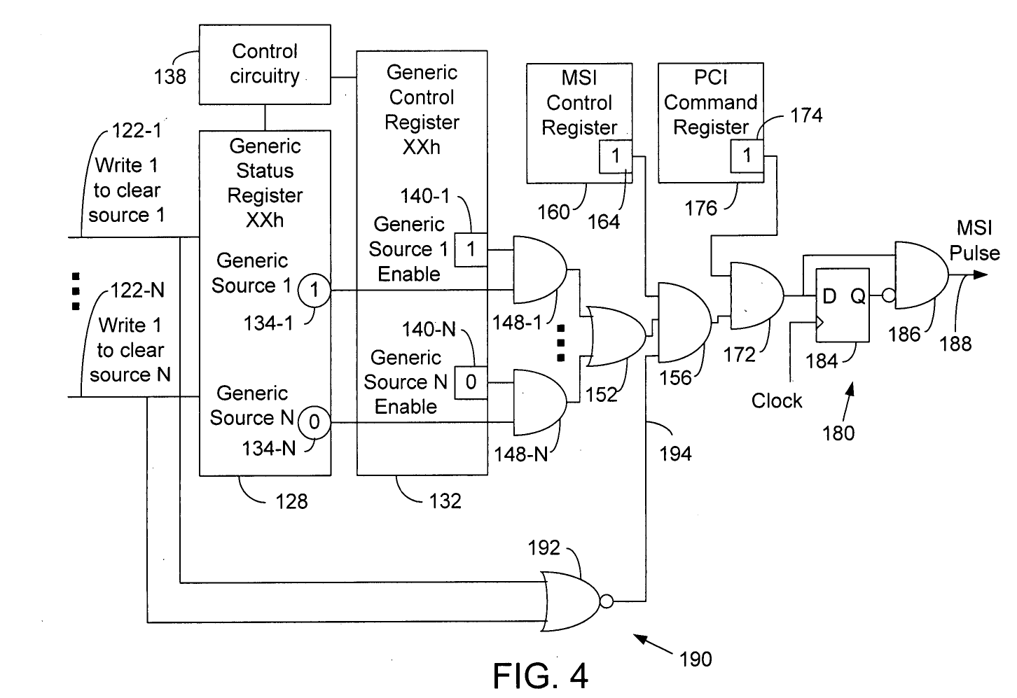

FIG. 2 illustrates an example of a system in which the MSI signal creation circuitry of the inventions may reside. However, the systems of the inventions are not restricted to the details of FIG. 2. Referring to FIG. 2, a system includes a processor 74 (also called a CPU), a memory controller hub (MCH) 78, memory 80, and an input/output controller hub (ICH) 82. ICH 82 includes interrupt circuitry 84 and interrupt circuitry 88. Interrupt circuitry 84 receives interrupts from device 92 and interrupt circuitry 88 receives interrupts from device 94. In a typical computer system, there would be several additional devices and other chips, not illustrated in FIG. 2. The circuitry of FIGS. 4-6 may reside in interrupt circuitry 84 or 88. Similar interrupt circuitry maybe in MCH 78 or other chips. Note that although an MCH and ICN are illustrated in FIG. 2, the invention may work in an interface chip that is not an MCH or an ICH. Further, the memory controller may be on the same chip as the processor.

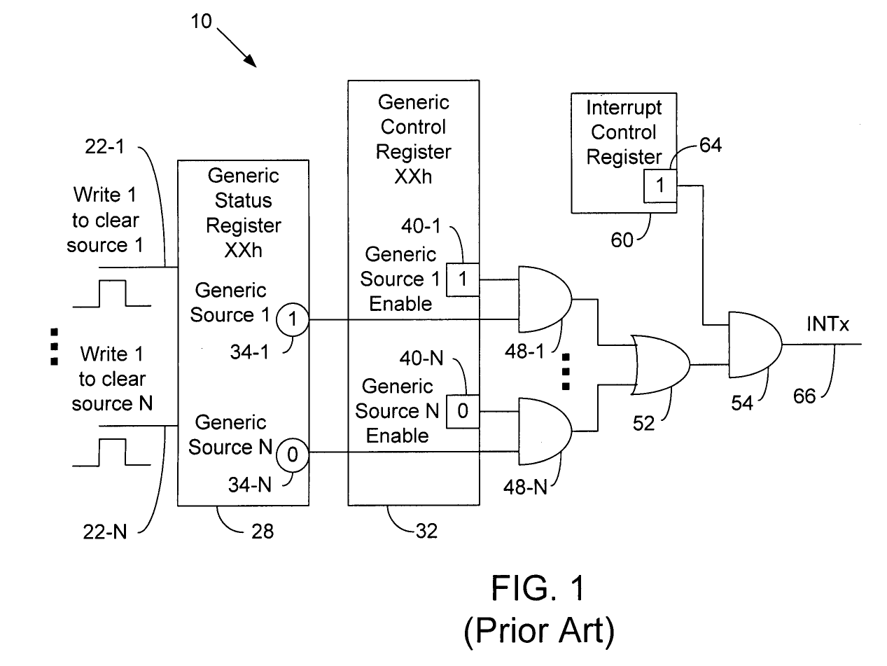

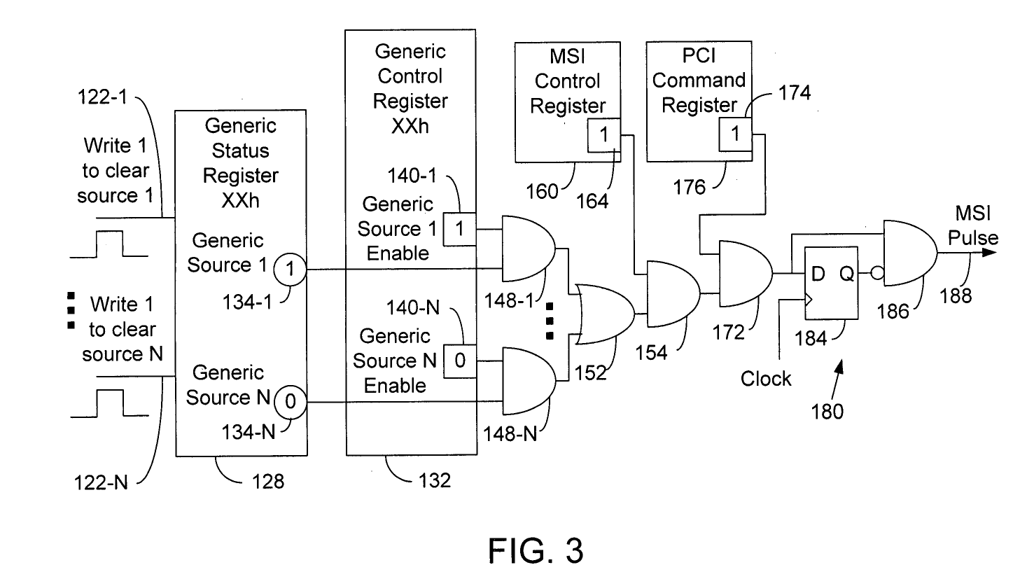

FIG. 3 represents a simple implementation of circuitry to produce MSI signals. After FIG. 3 is described, some defects of it will be explained. In the circuitry of FIG. 3, the original level trigger organization of FIG. 1 is reused and assertion detection logic and a MSI generation circuit are added to the original INTx output. Referring to FIG. 3, a chip includes a generic interrupt event status register and clear register circuit 128 (hereinafter “status register circuit 128”). Status register circuit 128 functions as a latch for interrupt event pulses captured by external logic and provided from event sources 1 . . . N on conductors 122-1 . . . 122-N. A latch of status register circuit 128 is cleared by writing a value of “1” to a register input for the specific bit for the source event. In this example, saying a register bit is cleared means it is changed from “1” to “0.” There may be N event sources. Although FIG. 3 illustrates status register circuit 128 as a single box, it may be comprised of multiple physically separate circuits.

Generic interrupt control register circuit 132 functions as a latch for the host command to enable interrupt reporting for a specific event. A value of “1” indicates enable. The specific control bit is cleared by writing “0” to a register input. The figure represents N control bits. Although FIG. 3 illustrates generic interrupt control register circuit 132 as a single box, it may be comprised of multiple physically separate circuits.

AND logic 148-1 . . . 148-N each receive a status source signal 01 . . . signal N from outputs 134-1 . . . 134-N of status register circuit 128 and a source enable signal from outputs 140-1 . . . 140-N from interrupt control register circuit 132. Outputs of AND logic 148-1 . . . 148-N are provided to an OR logic 152. The output of OR logic 152 is provided as an input to AND logic 154. Accordingly, if for any of the sources, both the status source signal and the source enable signals are asserted (high), the output of OR logic 52 is also asserted.

MSI control register circuit 160 functions as a latch for a host command to enable global interrupt reporting for the device interrupt logic. A value of “1” indicates enable. The specific control bit is cleared by writing “0” to a register input. In some embodiments, a PCI command register circuit 176 is also included even though it is redundant from the perspective of this invention. A “1” at output 174 indicates enable.

AND logic 154 receives an interrupt enable signal from output 164 of MSI control register circuit 160. AND logic 154 gates the captured event as presented by OR logic 152. The gate of AND logic 154 is closed when the control bit of MSI control register circuit 160 is clear (“0”, logic low voltage, in this example). The output of AND logic 154 is provided to AND logic 172, which also receives an output 174 of a bus master enable output 174 of PCI command register circuit 176. In some embodiments, MSI control register circuit 160 is at 92h and MSI control register circuit 176 is at 04h of the host PCI device, and output 164 is a bit 0 of the register and output 174 is a bit 2 of the register.

In the example of FIGS. 3-5, outputs 134-1 and 140-1 are “1” and outputs 134-N and 140-N are “0.” Output 164 and 176 are “1”. Accordingly, the output of AND logic 148-1 is “1”, the output AND logic 148-N is “0”, the output of OR logic 152 is “1,” the output of AND logic 154 is “1,” and AND logic 172 is “1”.

The output of AND logic 172 is provided to pulse generation logic 180, which includes a flip-flop (latch) 184 and logic 186. One input to AND logic 186 is the output of AND logic 172 and another input to AND logic 186 is an inverse of the output of flip-flop 184. The output of AND logic 186 is the MSI on conductor(s) 188.

In FIG. 3, the MSI message will occur when a transition from 0 (low) to 1 (high) is provided by OR logic 152 when the signals at outputs 164 and 174 are set to enable (high). Pulse generation logic 180 will respond to the transition in OR logic 152 with a single pulse that will be later translated as a message in the host bus (not shown).

In the circuitry of FIG. 3, the following are at least three driver error scenarios under edge semantics.

(1) ISR not clearing all detected events. In this case, the ISR when looking for the event will find the first status bit, service it, clear it and exit without servicing all status bits. As a consequence, all subsequent events are lost and no further message will be sent by the controller. (See situation 4 in table 1.)

(2) Event vs. clearing; race condition (multi-register): This case could be typical where there are multiple interrupt status registers. The ISR could access the first status register, determine all events, clear the register, and move to the next status register. The ISR will not be aware of the new event as it recently cleared the first status register. However, a new message will not be generated as the second register could still have pending uncleared bits. (See situation 6 in table 1.)

(3) Event vs. clearing; race condition (single-register): Race condition between the ISR clear and an event being recorded at the same time. The same conditions as in the multiple registers apply with the caveat that the boundary condition makes this event to be atypical. However, the probability of this occurrence is not zero and the consequences can be severe as to system stopping to function or data corruption. (See situation 6 in table 1.)

Yet another opportunity for error is when there is an interrupt event before software enables MSI capability. (See situation 7 in table 1.)

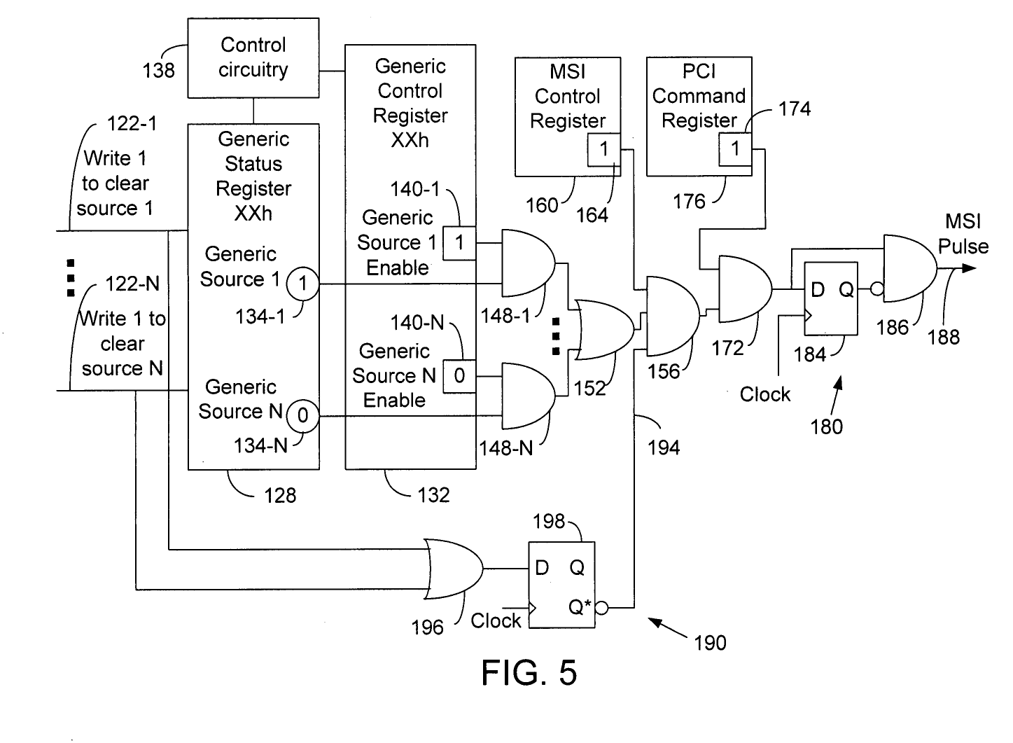

FIGS. 4 and 5 provide proposed enhancements to the circuit of FIG. 3 to overcome these problems by letting MSI interrupt logic proxy level trigger behavior. Table 1, below, summarizes the expected behavior of an MSI circuitry that will suffice to simulate the level trigger semantics under the assumption that the MSI target logic in the CPU (local APIC) buffers at least two events (the event being processed and a pending event).

TABLE 1

| | Wire-mode | |
|---|---|---|
| | action | |
| Interrupt Register(s) | (INTx) | MSI Action |
| 1. All interrupt event bits ‘0’ | Wire inactive | No action |
| 2. One or more bits set to ‘1’ | Wire active | Send message |
| 3. One or more bits set to ‘1’, new | Wire active | No action |
| bits set to ‘1’ not yet been serviced | | |
| 4. Two or more bits set to ‘1’, | Wire active | Send message |
| software clears some, but not all, bits | | |
| 5. One or more bits set to ‘1’, | Wire inactive | No action |
| software clears all bits | | |
| 6. Software clears one or more bits, | Wire active | Send message |
| and one or more bits are set on the | | |
| same clock | | |
| 7. Software enables MSI and one or | Wire active | Send message |
| more bits were previously set | | |

In situation 1 (of table 1), all interrupt event bits (from conductors 122-1 . . . 122-N) are ‘0’, meaning there are not interrupt events. Accordingly, the INTx conductor 66 in FIG. 1 would be inactive (a logical low) and there is not an MSI (no action).

In situation 2, at least one bit is set to ‘1’, meaning there is at least one interrupt event. Accordingly, the INTx conductor 66 in FIG. 1 would be active (a logical high) and there would be an MSI (send message).

In situation 3, at least one bit is set to ‘1’, meaning there is at least one interrupt event. A new bit gets set to ‘1’ prior to servicing of the at least one previously set bit. The INTx signal conductor 66 in FIG. 1 would be inactive (a logical low) and there would not be an MSI (no action). The reason for this is that since a bit is already set, there already has been an MSI and there is no need to have another one since the pre-existing interrupts had not yet been serviced.

In situation 4, at least two bits are set to ‘1’, and software clears some, but not all, bits. In this case, the INTx signal conductor 66 in FIG. 1 would be active, and an MSI would be sent because there are still unserviced interrupts.

In situation 5, at least one bit is set to ‘1’ and the software clears all bits. Since all interrupts have been serviced, the INTx signal on conductor 66 would be inactive and an MSI is not sent.

In situation 6, software clears at least one bit and at least one bit is set on the same clock. In this case, there is a race condition so the INTx signal on conductor 66 would be active and an MSI would be sent. In this disclosure, the term “same clock” means during the same relevant activity of the clock signal. For example, if the circuitry responds in a single data rate fashion, the relevant clock activity may be a clock period (or in some embodiments, more than one clock period). If the circuitry responds in a double data rate fashion, the relevant clock activity may be a half clock period (or in some embodiments multiple half clock periods).

In situation 7, software enables MSI and at least one bit was previous set. In this case, the INTx signal on conductor 66 would be active, and an MSI would be sent because the MSI capability is now enabled and interrupts are waiting to be serviced.

The circuitry of FIG. 4 is the same as in FIG. 3 except that FIG. 4 includes a re-arming logic 190 in the form of NOR logic 192 and AND logic 156 to receive the output of NOR logic 192. Table 2 shows the NOR logic for signals on two conductors 122-1 . . . 122-N.

TABLE 2

| Signal on | Signal on | Output of |
|---|---|---|
| conductor | conductor | NOR logic |
| 122-1 | 122-N | 192 |
| 0 | 0 | 1 |
| 1 | 0 | 0 |
| 0 | 1 | 0 |
| 1 | 1 | 0 |

Table 2 can be extrapolated to show that if all signals on conductors 122-1 . . . 122-N are low (0), then the output of NOR logic 192 is high (1), but if any of the signals on conductors 122-1 . . . 122-N is high, then the output of NOR logic 192 is low (0). AND logic 156 also received the output of OR logic 152 and output 164 of MSI control register 160.

In operation, interrupt event pulses are received one or more of conductors 122-1 . . . 122-N. Once the pulse(s) has passed, all conductors 122-1 . . . 122-N are “0.” The output of NOR logic 192 is “1” when all the conductors are “0.” If another event occurs in the same clock when the previous events are being cleared from register 128, the output of NOR logic 192 is temporarily “0” but quickly returns to “1.” This allows another pulse to travel through AND logic 156 and create another MSI pulse. By contrast, in the case of FIG. 3, there is not another MSI pulse.

The contents of circuits 128 and 132 may be at least partially controlled by control circuitry 138.

Other implementations are possible and typically the final circuitry design would be tailored to the available interrupt routing logic of the specific design. However, according to some embodiments of the invention, the circuitry satisfies Table 1 so as to avoid race conditions, which otherwise could cause the loss of interrupt event processing.

Note that the circuits of FIG. 4 can be changed and still accomplish the objectives. For example, AND logic 156 and 172 could be replaced by a single AND logic that receives the signals received by AND logic 156 and 172 as shown in FIG. 4. The signals from outputs 164 and 176 may be ANDed and the resulting signal applied to AND logic 156 (so that AND logic 172 would not be used as shown in FIG. 4).

FIG. 5 illustrates an alternative to re-arming circuitry of FIG. 4. The circuitry of FIG. 4 is the same as that of FIG. 4, except that re-arming circuitry 190 includes NOR logic 192 and a D-latch, flip-flop 196. In particular, in the embodiments of FIG. 5, the output of OR logic 196 is provided to the D-input of flip-flop 198. The Q* (inverse of Q) output of flip-flop 198 is provide to conductor 194 to AND logic 156. This allows for the re-arming circuitry 190 to remove dependencies on specific timing of sources (on 122-1 . . . 122-N) from entering status register circuit 128. The re-arming circuitry of FIG. 5 may provide a cleaner re-arming signal than is provided by the re-arming circuitry of FIG. 4.

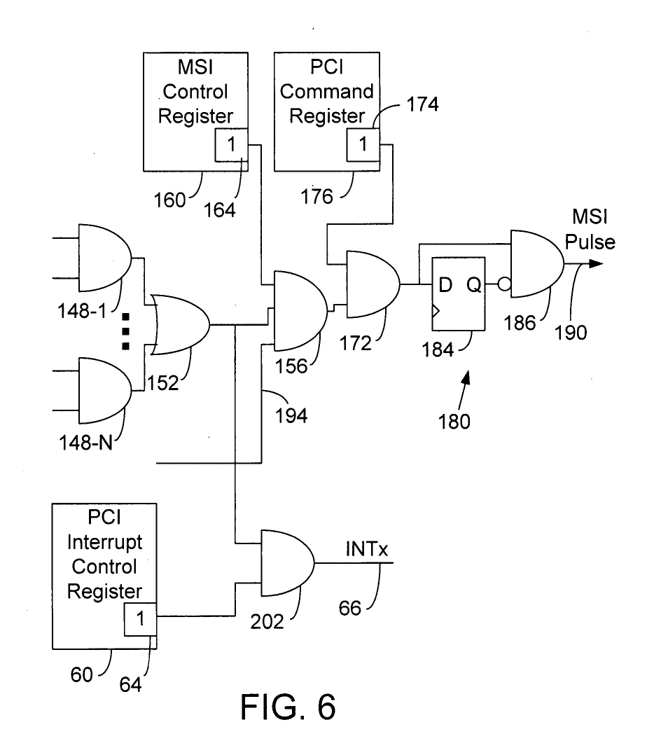

FIG. 6 illustrates a portion of FIGS. 4 and 5 in combination with a portion of FIG. 1 to show circuitry that can produce either INTx signals or MSI signals. AND logic 202 joins an output of PCI control register 60 with the output of OR logic 152. Other portions of FIG. 4 or are not shown in FIG. 6 because of limited space.

In the figures, a square output indicates read/write (R/W) and a circle output indicates read/write clear (R/WC), although the inventions are not required to include these details.

The logic of FIGS. 3-6 uses is designed for particular values of high and low signals. However, the logic could be changed to respond to different values of high and low signals. For example, the logic could be changed such the logic would provide the same results if some or all the high voltages were changed to low voltages and some or all the low voltages were changed to high voltages.

The term “pin” is intended to be interpreted broadly to include a pin, ball array or other contact to a pad or other interface to a chip.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The inventions are not restricted to the particular details described herein. Indeed, many other variations of the foregoing description and drawings may be made within the scope of the present inventions. Accordingly, it is the following claims including any amendments thereto that define the scope of the inventions.

1. A chip comprising:
a status register circuit coupled to conductors to receive interrupt event signals to provide source signals corresponding to the interrupt event signals;
a control register circuit to provide source enable signals for selective ones of the interrupt sources;
a re-arming logic circuit coupled to the conductors to receive the interrupt event signals and provide a re-arming signal;
first logic circuit to receive the source signals, the source enable signals, and the re-arming signal to provide an initial interrupt signal; and
message signaled interrupt (MSI) signal pulse generation logic to receive the initial interrupt signal and provide an MSI signal in response thereto.

2. The chip of claim 1, wherein the MSI signal pulse generation logic provides an MSI signal when at least one interrupt event bit is set in the status register circuitry but not all interrupt event bits get serviced.

3. The chip of claim 1, wherein the MSI signal pulse generation logic provides an MSI signal when set interrupt event bits in the status register circuitry are cleared and at least one interrupt event bit is set during a same clock during which the interrupt event bits are cleared.

4. The chip of claim 1, wherein the re-arming logic circuit includes NOR logic to receive the interrupt event signals and provides an output signal to the first logic circuit.

5. The chip of claim 1, wherein the re-arming logic circuit includes NOR logic to receive the interrupt event signals and provide a signal to a latch, which in turn provides an output signal to the first logic circuit.

6. The chip of claim 1, wherein the MSI signal pulse generation logic does not provide an MSI signal when at least one interrupt event bit is set in the status register circuitry and a new interrupt event bit in the status register circuitry is set prior to servicing of the at least one previously set interrupt event bit.

7. The chip of claim 1, wherein the MSI signal pulse generation logic provides an MSI signal following software enabling MSI capability and wherein at least one interrupt event bit was set in the status register circuitry prior to the enabling of the MSI capability.

8. The chip of claim 1, wherein the (MSI) signal pulse generation logic includes a latch and AND logic, wherein the latch receives the output of the first logic circuit and the AND logic receive the output of the first logic circuit and an inverted output of the latch.

9. The chip of claim 1, wherein the first logic includes:
a plurality of first AND logic to receive the source signals from the status register circuit and the source enable signals from the control register circuit;
OR logic to receive outputs of the plurality of first AND logic;
AND logic to receive the output of the OR logic, and the re-arming signals, and at least one of the enable signals.

10. The chip of claim 1, further comprising:
MSI control register circuitry including an output to provide a first additional enable signal to the first logic circuit; and
PCI command register circuitry to a second additional enable signal to the first logic circuit.

11. A chip comprising:
conductors to carry interrupt event signals; and
circuitry to selectively provide message signaled interrupt (MSI) signals, wherein an MSI signal is provided when set interrupt event bits in the status register circuitry are cleared and at least one interrupt event bit is set during a same clock during which the interrupt event bits are cleared.

12. The chip of claim 11, wherein the circuitry includes re-arming logic circuit to receive the interrupt event signals and a re-arming signal to the circuitry.

13. The chip of claim 12, wherein the circuitry includes:
first logic circuit to receive source signals, source enable signals, and the re-arming signal to provide an initial interrupt signal; and
MSI signal pulse generation to provide the MSI signals in response to the initial interrupt signal.

14. The chip of claim 13, wherein the MSI signal pulse generation logic includes a latch and AND logic, wherein the latch receives the output of the first logic circuit and the AND logic receives the output of the first logic circuit and an inverted output of the latch.

15. A system comprising:
a device to provide interrupt event signals;
a first chip including:
a status register circuit coupled to conductors to the receive interrupt event signals to provide source signals corresponding to the interrupt event signals;
a control register circuit to provide source enable signals for selective ones of the interrupt sources;
a re-arming logic circuit coupled to the conductors to receive the interrupt event signals and provide a re-arming signal;
first logic circuit to receive the source signals, the source enable signals, and the re-arming signal to provide an initial interrupt signal; and
message signaled interrupt (MSI) signal pulse generation logic to receive the initial interrupt signal and provide an MSI signal in response thereto.

16. The system of claim 15, wherein the MSI signal pulse generation logic provides an MSI signal when at least one interrupt event bit is set in the status register circuitry but not all interrupt event bits get serviced.

17. The system of claim 15, wherein the MSI signal pulse generation logic provides an MSI signal when set interrupt event bits in the status register circuitry are cleared and at least one interrupt event bit is set during a same clock during which the interrupt event bits are cleared.

18. The system of claim 15, wherein the re-arming logic circuit includes NOR logic to receive the interrupt event signals and provides an output signal to the first logic circuit.

19. The system of claim 15, wherein the re-arming logic circuit includes NOR logic to receive the interrupt event signals and provide a signal to a latch, which in turn provides an output signal to the first logic circuit.

20. The system of claim 15, wherein the MSI signal pulse generation logic does not provide an MSI signal when at least one interrupt event bit is set in the status register circuitry and a new interrupt event bit in the status register circuitry is set prior to servicing of the at least one previously set interrupt event bit.

21. The system of claim 15, wherein the MSI signal pulse generation logic provides an MSI signal following software enabling MSI capability and wherein at least one interrupt event bit was set in the status register circuitry prior to the enabling of the MSI capability.

22. The system of claim 15, wherein the (MSI) signal pulse generation logic includes a latch and AND logic, wherein the latch receives the output of the first logic circuit and the AND logic receive the output of the first logic circuit and an inverted output of the latch.

23. The system of claim 15, wherein the first logic includes:
a plurality of first AND logic to receive the source signals from the status register circuit and the source enable signals from the control register circuit;
OR logic to receive outputs of the plurality of first AND logic;
AND logic to receive the output of the OR logic, and the re-arming signals, and at least one of the enable signals.

24. The system of claim 15, further comprising:
MSI control register circuitry including an output to provide a first additional enable signal to the first logic circuit; and
PCI command register circuitry to a second additional enable signal to the first logic circuit.
